(19) United States
(12) Patent Application Publication
(10) Pub. No.: US 2007/0121680 A1
(43) Pub. Date: May 31, 2007

(54) METHOD AND SYSTEM FOR HANDLING MULTICAST EVENT CONTROL SYMBOLS

(75) Inventors: Barry Wood, Dunrobin (CA); Stephane Gagnon, Kanata (CA)

Correspondence Address: HOGAN & HARTSON LLP, ONE TABOR CENTER, SUITE 1500, 1200 SEVENTEENTH ST, DENVER, CO, 80202, US

(73) Assignee: TUNDRA SEMICONDUCTOR CORPORATION, KANATA, ON (CA)

(21) Appl. No.: 11/554,332

(22) Filed: Oct. 30, 2006

Related U.S. Application Data
(60) Provisional application No. 60/740,400, filed on Nov. 28, 2005.

(51) Int. Cl. H04J 3/06

(52) U.S. Cl. 370/516

(57) ABSTRACT

A packet switching system comprises a first switch and a second switch. The first switch includes a first receive port, a first plurality of transmit ports, a first switch fabric, a first reference clock signal input and a first multicast control symbol input/output port coupled to the first plurality of transmit ports for inputting a multicast control signal to be transmitted. The second switch includes a second receive port, a second plurality of transmit ports a second switch fabric, a second reference clock signal input and a second multicast control symbol input/output port coupled to the second receive port for outputting a received multicast control symbol. In operation, a multicast control symbol is generated in hardware synchronized with a reference clock signal and the multicast control symbol directly to the first plurality of transmit ports.

### RELATED APPLICATION

The present application claims priority of U.S. Provisional Application Ser. No. 60/740,400 filed 28 Nov. 2005, which is incorporated herein in its entirety by this reference.

### FIELD OF THE INVENTION

The present invention relates to a method and switch for handling multicast event control symbols.

### BACKGROUND OF THE INVENTION

Multicast Event Control Symbols (MECS) are used to distribute regularly occurring events throughout a RapidIO system. For example, notification that a frame of antenna data has been completely received, distribution of an accurate real time clock, or a ‘heartbeat’ for determining system health. RapidIO is a trademark of the RapidIO Trade Association, a non-profit corporation controlled by its members, directs the development and drives the adoption of the RapidIO architecture.

Referring to FIG. 1 there is illustrated a known packet switching system. The packet switching system 10 uses the RapidIO protocol and includes a software Multicast Control Symbol (MECS) Originator 12, a first node 14, a second node 16, coupled to the first via a link 18 and a software Multicast Control Symbol (MECS) Receiver 20.

RapidIO has defined a standard Multicast Control Symbol (MECS) of four bytes. A MECS is used to signal events in a system, for example a time tick. The implementation of MECS is vendor specific.

In operation, originating software 12 originates the MECS at a rate determined by an interrupt. When a RapidIO port receives a MECS, it signals all other ports of the fact that a MECS has been received. The receiving port forwards the symbol to the other ports. For example, the MECS is replicated by hardware by the node 14 to all receiving nodes 16. Receiving software 20 is notified of the MECS reception by the interrupt.

The standard method for generating and distributing Multicast Event Control Symbols (MECS) requires that all of the ports on a switch support two signals:
‘Received an MECS’ output signal indicates that a MECS was received on the port
‘Transmit MECS’ input signal—the wired ‘OR’ of the ‘Received an MECS’ signal for all other ports.

Each port has a standard control value that determines whether assertion of the ‘Transmit MECS’ signal will cause a MECS to be transmitted.

In the Rapid IO standard, the generation and reception of Multicast Event Control Symbols (MECS) is assumed to be done by software. This is not optimal, for the following reasons.
The generation of Multicast Event Control symbols by software consumes significant system compute resources. For example, distributing a real time clock that has a period of 1 millisecond requires that the generating software process 1000 time based interrupts per second, and that the receiving software process 1000 interrupts per second. This interrupt processing can consume upwards of 10% of each processors compute capacity.
Generation and reception of multicast event control symbols by software results in a wide variation in the actual times that the multicast event control symbols are generated, and received, due to varying software execution times on a processor.

Because of potential negative impact on processor resources, expanding use of multicast event control symbols (MECS) beyond the intended timing events is severely limited. An additional problem is that no other control mechanism was defined in the standard.

### SUMMARY OF THE INVENTION

An object of the present invention is to provide an improved method and system for handling multicast event control symbols (MECS).

The present disclosure specifies an optimum method for generating multicast event control symbols using hardware. This method provides a very efficient implementation of multicast event control symbol propagation, as well as a means for signaling the occurrence of multicast event control symbols to hardware appliances. The method of hardware generation/propagation of multicast event control symbols results in low jitter for the creation/propagation of multicast event control symbols, and eliminates any software overhead required for generation.

In accordance with an aspect of the present invention there is provided a packet switching system comprising a receive port, a plurality of transmit ports, a switch fabric for selectively coupling the receive port to the transmit ports, a reference clock signal input and a multicast control symbol input/output port coupled to the receive port for outputting a received multicast control symbol and to the plurality of transmit ports for inputting a control signal to be transmitted; whereby multicast control symbols are synchronized to the reference clock signal.

In accordance with a further aspect of the present invention there is provided a packet switching system comprising a first switch including a first receive port, a first plurality of transmit ports, a first switch fabric for selectively coupling the receive port to the transmit ports, a first reference clock signal input and a first multicast control symbol input/output port coupled to the first receive port for outputting a received multicast control symbol and to the first plurality of transmit ports for inputting a multicast control signal to be transmitted and at least one second switch including a second receive port, a second plurality of transmit ports, a second switch fabric for selectively coupling the receive port to the transmit ports, a second reference clock signal input and a second multicast control symbol input/output port coupled to the second receive port for outputting a received multicast control symbol and to the second plurality of transmit ports for inputting a control signal to be transmitted; whereby multicast control symbols are synchronized to a reference clock signal.

In accordance with another aspect of the present invention there is provided a method of operating a packet switching system comprising a first switch including a first receive port, a first plurality of transmit ports, a first switch fabric for selectively coupling the receive port to the transmit ports, a first reference clock signal input and a first multicast control symbol input/output port coupled to the first receive port for outputting a received multicast control symbol and to the first plurality of transmit ports for inputting a control signal to be transmitted; and at least one second switch including a second receive port, a second plurality of transmit ports, a second switch fabric for selectively coupling the receive port to the transmit ports, a second reference clock signal input and a second multicast control symbol input/output port coupled to the second receive port for outputting a received multicast control symbol and to the second plurality of transmit ports for inputting a control signal to be transmitted, said method comprising the steps of generating a reference clock signal, generating a multicast control symbol in dependence upon the reference clock signal, coupling the multicast control symbol directly to the first plurality of transmit ports and transmitting the multicast control symbol to the second receive port.

### BRIEF DESCRIPTION OF THE DRAWINGS

The present invention will be further understood from the following detailed description with reference to the drawings in which:

FIG. 1 illustrates a known packet switching system;

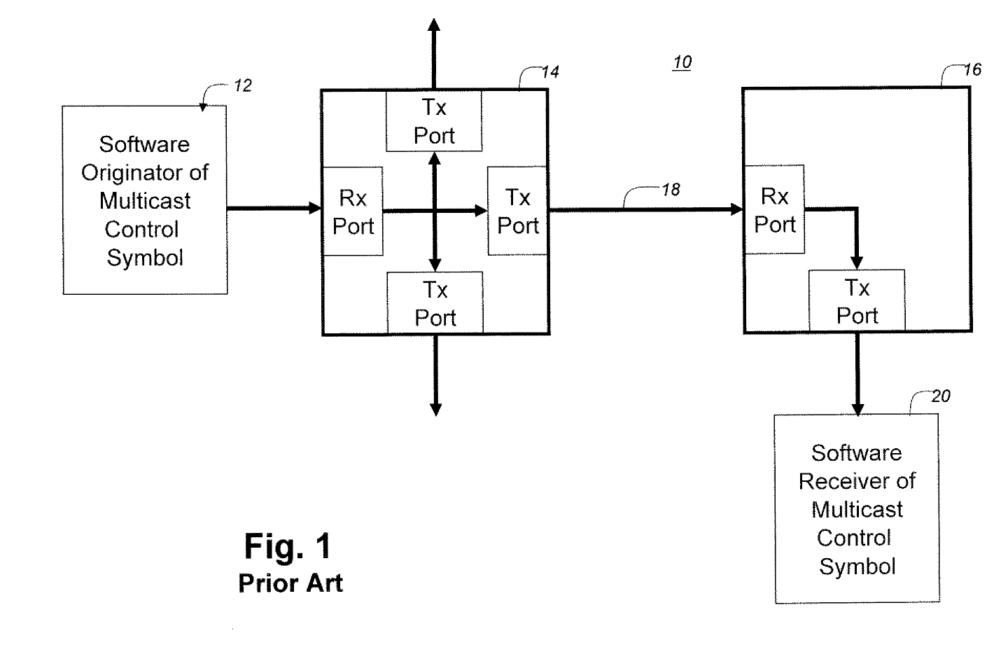

FIG. 2 illustrates a packet switching system in accordance with an embodiment of the present invention; and

FIG. 3 illustrates a packet switching system in accordance with another embodiment of the present invention.

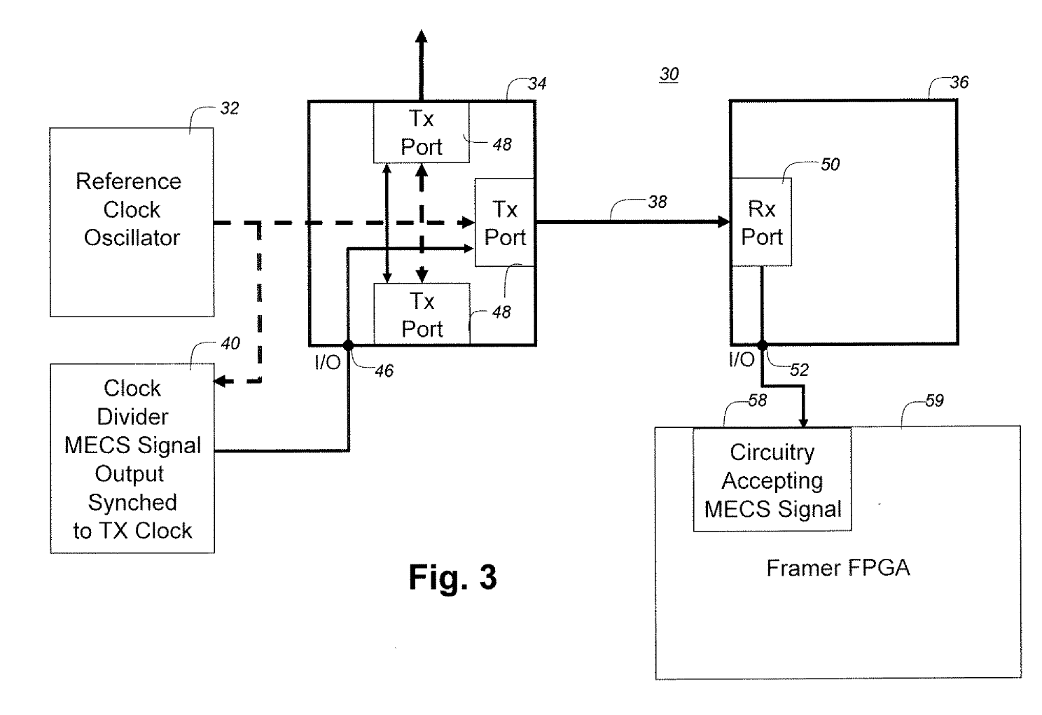

### DETAILED DESCRIPTION OF THE PREFERRED EMBODIMENT

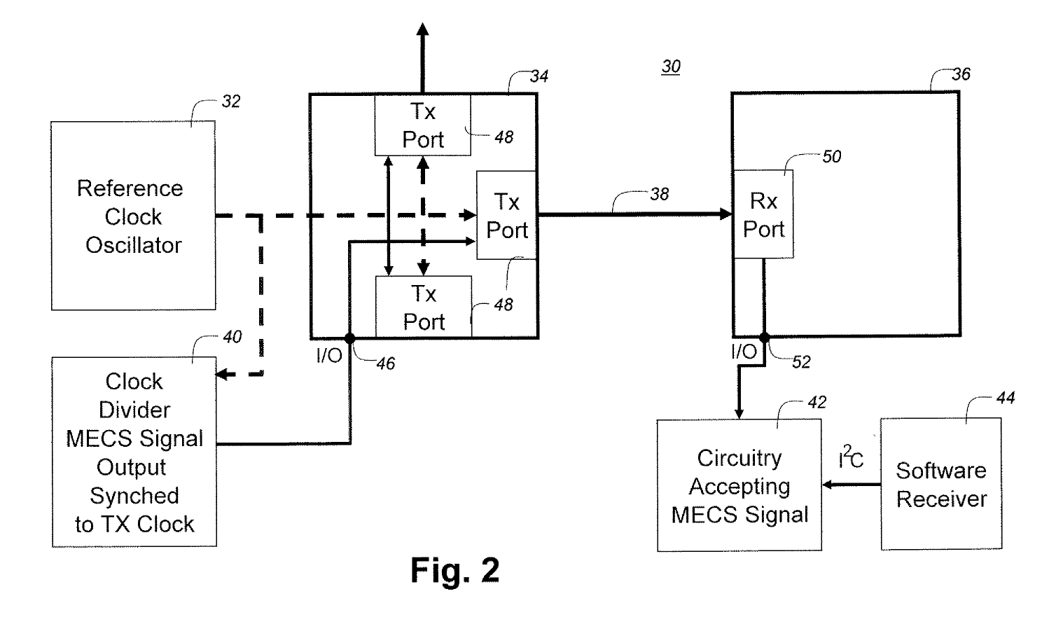

Referring to FIG. 2 there is illustrated a packet switching system for handling multicast event control symbols in accordance with an embodiment of the present invention. The packet switching system 30 includes a reference clock 32, a first packet switch 34, a second packet switch 36 coupled 38 with the first packet switch 34, a MECS symbol generator 40, a MECS acceptor 42 and a software receiver. The MECS symbol generator 40 is coupled to the first packet switch 34 via a first input/output 46. The reference clock 32 is coupled to transmitter ports 48 of first packet switch 34. A receiver port 50 of second packet switch 36 is coupled to the MECS acceptor 42 via a second input/output 52.

Referring to Fig. there is illustrated a packet switching system for handling multicast event control symbols in accordance with another embodiment of the present invention. The packet switching system 30 includes a reference clock 32, a first packet switch 34, a second packet switch 36 coupled 38 with the first packet switch 34, a MECS symbol generator 40, a MECS acceptor 58 and a hardware receiver 59, in the form of a framer field programmable gate array (FPGA). The MECS symbol generator 40 is coupled to the first packet switch 34 via a first input/output 46. The reference clock 32 is coupled to transmitter ports 48 of first packet switch 34. A receiver port 50 of second packet switch 36 is coupled to the MECS acceptor 58 via a second input/output 52.

The present embodiments of the invention leverages the existing infrastructure for generating and distributing MECS. The present embodiment adds two external signals to the standard method; namely:
‘HW Request MECS’ external input signal—externally driven trigger to transmit an MECS
‘HW Received an MECS’ external output signal—indicates that an MECS has been received

The ‘HW Request MECS’ signal is added to the signal's OR'ed together to create the ‘Transmit MECS’ input signal. The ‘HW Received an MECS’ output is the wired OR of all ports ‘Received and MECS’ signals.

In order to transmit regular events with minimal jitter, the ‘HW Request MECS’ signal is driven synchronously with the reference clock 32 used to drive the transmitter 46 on every link. The standard RapidIO capability, which allows MECS to be transmitted embedded within packets is incorporated into the design to ensure that MECS will be transmitted at the time the ‘HW Request MECS’ signal is asserted.

Additional refinements must be used to eliminate the variation in transmission intervals associated with the propagation of a RapidIO MECS. Variation in transmission intervals occur because of the needs of the RapidIO protocol. The RapidIO specification requires that an idle sequence be transmitted at a specified interval to ensure continued correct operation of the RapidIO link. RapidIO also requires that a buffer status control symbol be transmitted within a specified interval.

In order to avoid transmission of an idle sequence and a buffer status control symbol interfering with transmission of the RapidIO MECS, a change is made to the standard implementation of MECS. Instead of transmitting the MECS as soon as possible upon reception of a ‘Transmit MECS’ request, the transmission is delayed by a period of time sufficient to transmit an idle sequence and a buffer status control symbol. If an idle sequence and/or a buffer status control symbol need to be transmitted, they can be transmitted at that point. This eliminates the variability in time of the transmission of the MECS, thus resulting in completely predictable transmission of the MECS throughout a RapidIO system.

Numerous other modifications, variations and adaptations may be made to the particular embodiments of the invention described above without departing from the scope of the invention as defined in the claims.

What is claimed is:

1. A packet switching system comprising:
a receive port;
a plurality of transmit ports;
a switch fabric for selectively coupling the receive port to the transmit ports;
a reference clock signal input; and
a multicast control symbol input/output port coupled to the receive port for outputting a received multicast control symbol and to the plurality of transmit ports for inputting a control signal to be transmitted, whereby multicast control symbols are synchronized to the reference clock signal.

2. A system as claimed in claim 1 including a multicast control symbol generator coupled to the control symbol input/output port.

3. A system as claimed in claim 2 including a reference clock coupled to the reference clock input.

4. A system as claimed in claim 2 wherein the multicast control symbol generator includes a clock input for coupling to a reference clock.

5. A system as claimed in claim 2 wherein the multicast control symbol generator does not include a clock input for coupling to a reference clock

6. A system as claimed in claim 1 including a multicast control symbol acceptor coupled to the multicast control symbol input/output port.

7. A system as claimed in claim 6 including a software receiver coupled to the multicast control symbol acceptor.

8. A system as claimed in claim 6 including a hardware receiver coupled to the multicast control symbol acceptor.

9. A system as claimed in claim 1 including a software multicast control symbol originator coupled to the receive port.

10. A packet switching system comprising:
a first switch including a first receive port, a first plurality of transmit ports, a first switch fabric for selectively coupling the receive port to the transmit ports, a first reference clock signal input and a first multicast control symbol input/output port coupled to the first plurality of transmit ports for inputting a multicast control signal to be transmitted; and
at least one second switch including a second receive port, a second plurality of transmit ports, a second switch fabric for selectively coupling the receive port to the transmit ports, a second reference clock signal input and a second multicast control symbol input/output port coupled to the second receive port for outputting a received multicast control symbol,
whereby multicast control symbols are synchronized to a reference clock signal.

11. A system as claimed in claim 10 including a multicast control symbol generator coupled to the first multicast control symbol input/output port.

12. A system as claimed in claim 10 including a reference clock coupled to the first reference clock input.

13. A system as claimed in claim 10 wherein the control symbol generator includes a clock input for coupling to a reference clock.

14. A system as claimed in claim 11 including a control symbol acceptor coupled to the second multicast control symbol input/output port.

15. A system as claimed in claim 14 including a software receiver coupled to the multicast control symbol acceptor.

16. A system as claimed in claim 10 including a software multicast control symbol originator coupled to the first receive port.

17. A method of operating a packet switching system comprising a first switch including a first receive port, a first plurality of transmit ports, a first switch fabric for selectively coupling the receive port to the transmit ports, a first reference clock signal input and a first multicast control symbol input/output port coupled to the first plurality of transmit ports for inputting a control signal to be transmitted; and at least one second switch including a second receive port, a second plurality of transmit ports, a second switch fabric for selectively coupling the receive port to the transmit ports, a second reference clock signal input and a second multicast control symbol input/output port coupled to the second receive port for outputting a received multicast control symbol, said method comprising the steps of:
generating a reference clock signal;
generating a multicast control symbol in dependence upon the reference clock signal;
coupling the multicast control symbol directly to the first plurality of transmit ports; and
transmitting the multicast control symbol to the second receive port.

18. A method as claimed in claim 17 including the step of synchronizing the multicast control symbol to the reference clock signal.

19. A method as claimed in claim 17 wherein the step of transmitting the multicast control symbol uses the reference clock signal.

20. A method as claimed in claim 17 including the step of receiving the multicast control symbol at the second receive port.

21. A method as claimed in claim 17 where the transmission of the multicast control symbol is delayed to ensure that no RapidIO protocol artifacts induce jitter in the propagation of the multicast control symbol

22. A method as claimed in claim 20 including the step of directly coupling the multicast control symbol via the second input/output port to a multicast control symbol acceptor.

23. A method as claimed in claim 22 including the step of receiving in software the multicast control symbol from the multicast control symbol acceptor.

24. A method as claimed in claim 22 including the step of receiving in hardware the multicast control symbol from the multicast control symbol acceptor.
